(19) United States
(12) Patent Application Publication
(10) Pub. No.: US 2009/0013025 A1
(43) Pub. Date: Jan. 8, 2009

(54) MODEL TRANSMISSION APPARATUS AND MODEL TRANSMISSION METHOD

(75) Inventor: Shinichi SOEJIMA, Gotenba-shi (JP)

Correspondence Address: SUGHRUE MION, PLLC, 2100 PENNSYLVANIA AVENUE, N.W., SUITE 800, WASHINGTON, DC, 20037, US

(73) Assignee: TOYOTA JIDOSHA KABUSHIKI KAISHA, Toyota-shi (JP)

(21) Appl. No.: 12/164,302

(22) Filed: Jun. 30, 2008

(30) Foreign Application Priority Data
Jul. 2, 2007 (JP) 2007-174483

(51) Int. Cl. G06F 15/16

(52) U.S. Cl. 709/201

(57) ABSTRACT

A model transmission apparatus used when producing a system model. In the model transmission apparatus, models are transmitted between first computers and a second computer. The second computer includes a second transmission device that transmits a system model to each of the first computers. When the system model is transmitted, component models included in the system model are concealed. When at least one of the concealed component models included in the system model matches at least one corresponding component model stored in the first storage device of at least one of the first computers, the at least one of the first computers automatically replaces the at least one of the concealed component models included in the system model with the at least one corresponding component model stored in the first storage device of the at least one of the first computers.

### INCORPORATION BY REFERENCE

The disclosure of Japanese Patent Application No. 2007-174483 filed on Jul. 2, 2007, including the specification, drawings and abstract is incorporated herein by reference in its entirety.

### BACKGROUND OF THE INVENTION

1. Field of the Invention

The invention relates to a model transmission apparatus and a model transmission method.

2. Description of the Related Art

Recently, a technology, in which when components of a vehicle, and systems including the components in the entire vehicle are developed, simulation models (component models) corresponding to the components are produced, has been proposed. In the technology, the performance of the components and systems of the vehicle is evaluated using the component models and the simulation models of the systems of the entire vehicle, which are produced by combining the component models. By developing the components and systems using the component models and system models, it is possible to evaluate the components and systems without actually manufacturing the components and systems for testing. This reduces the cost of manufacturing the components and the like for testing. Also, because it is not necessary to manufacture the actual components and the like in the design and development phase, the time required to design the components and the like is reduced.

Japanese Patent Application Publication No. 2006-343858 (JP-A-2006-343858) describes a development method using the models. In the method, a model repository is shared between a component manufacturer and a system manufacturer that develops a system (for example, a vehicle, or an intake system for the vehicle) using the component developed by the component manufacturer. More specifically, first, the component manufacturer produces a component model by modeling an actuator or the like developed by the component manufacturer. Then, the component manufacturer registers data of the model in the model repository accessible to the system manufacturer. Then, the system manufacturer produces the system model using the component model registered by the component manufacturer, and supplies the system model to the component manufacturer. Thus, the component manufacturer can perform a simulation of the entire system using the system model supplied by the system manufacturer, while making modifications to the design of the component. That is, the component manufacturer can evaluate the performance of the entire system after making modifications to the component (component model in this case) produced by the component manufacturer to conduct a study for further increasing the performance. Thus, the component manufacturer can develop the component while evaluating the performance of the entire system. Therefore, it is possible to increase the performance of the component appropriate for the system, and to increase the efficiency of the operation, as compared to when the component manufacturer performs a simulation using only the component model produced by the component manufacturer.

A large number of components constitute the vehicle or the like. Therefore, different component manufacturers develop the respective components of the vehicle. In this case, each component manufacturer independently develops the component, and also develops the component model corresponding to the component. Accordingly, a plurality of different component manufacturers supply the component models to the system manufacturer. The system manufacturer produces the system model by combining the component models thus supplied.

The system manufacturer needs to supply the system model to each component manufacturer so that the component manufacturer can evaluate the performance of the entire system using the supplied system model, while making modifications to the design of the component. However, because the system model includes the component models supplied by the plurality of component manufacturers, if the system model is supplied to each component manufacturer, each component manufacturer that receives the system model learns the detailed structure and the like of the components produced by other component manufacturers, by analyzing the data of the component models produced by the other component manufacturers.

In most cases, unique technique of each component manufacturer, and the structure, specifications, and the like of the component are recorded in the component model. Therefore, each component manufacturer that supplies the component model may not want the other component manufacturers and the system manufacturer to learn the contents of the component model. However, when the development method described in the above publication No. 2006-343858 is employed, the data of the component model produced by each component manufacturer may be revealed to the other component manufacturers.

### SUMMARY OF THE INVENTION

The invention provides a model transmission apparatus and a model transmission method, which make it possible to efficiently perform development, while preventing data of a component model from being revealed to persons other than the developer of the component model.

An aspect of the invention relates to a model transmission apparatus used when producing or improving a system model that is used to perform simulation analysis of a system constituted by a plurality of components, and that is produced by combining component models corresponding to the components. The model transmission apparatus includes a plurality of first computers used by respective component model suppliers; and a second computer used by a system model producer. Each of the first computers includes a first input device through which a user inputs, to the first computer, at least one component model produced by the user, a first storage device that stores the at least one component model that is input, and a first transmission device that transmits the at least one component model that is input, to the second computer. The second computer includes a second storage device that stores the at least one component model transmitted by the first transmission device of each of the first computers, and a second transmission device that transmits, to each of the first computers, the system model produced by combining at least two component models among the component models stored in the second storage device of the second computer. When the system model is transmitted by the second transmission device, the component models included in the system model are concealed. When at least one of the concealed component models included in the system model transmitted by the second transmission device matches at least one corresponding component model stored in the first storage device of at least one of the first computers, the at least one of the first computers automatically replaces the at least one of the concealed component models with the at least one corresponding unconcealed component model stored in the first storage device of the at least one of the first computers.

In the above-described model transmission apparatus, basically, the concealed component models are transmitted to each of the first computers. Therefore, the component model suppliers cannot learn the contents of the component models included in the system model. However, among the concealed component models included in the system model, at least one component model developed by a component model supplier is replaced with at least one component model stored in the first storage device of the first computer for the component model supplier. Therefore, the component model supplier can evaluate the performance of the entire system while changing the design of the component model produced by the component model supplier The phrase “the component models are concealed” signifies that the contents of the component models and the structures and the specifications of the components corresponding to the component models are prevented from being analyzed.

Another aspect of the invention relates to a model transmission method used when producing or improving a system model that is used to perform simulation analysis of a system constituted by a plurality of components, and that is produced by combining component models corresponding to the components. In the model transmission method, the models are transmitted between a plurality of first computers used by respective component model suppliers, and a second computer used by a system model producer. The model transmission method includes inputting at least one component model produced by a user to a first storage device of each of the first computers; transmitting the at least one component model input to the first storage device, from each of the first computers to the second computer; storing the at least one component model transmitted from each of the first computers to the second computer, in a second storage device of the second computer; and transmitting the system model produced by combining at least two component models among the component models stored in the second storage device of the second computer, from the second computer to each of the first computers. When the system model is transmitted from the second computer to each of the first computers, the component models included in the system model are concealed. When at least one of the concealed component models included in the system model transmitted to each of the first computers matches at least one corresponding component model stored in the first storage device of at least one of the first computers, the at least one of the concealed component models is automatically replaced with the at least one corresponding unconcealed component model stored in the first storage device of the at least one of the first computers.

According to the invention, it is possible to provide the model transmission apparatus and the model transmission method that make it possible to efficiently perform development while preventing the data of the component model from being revealed to persons other than the developer of the component model.

### BRIEF DESCRIPTION OF THE DRAWINGS

The features, advantages thereof, and technical and industrial significance of this invention will be better understood by reading the following detailed description of embodiments of the invention, when considered in connection with the accompanying drawings, in which:

FIG. 1A is a diagram illustrating a component model;

FIG. 1B is a diagram illustrating a system model;

FIG. 2 is a diagram schematically showing a configuration of a model transmission apparatus according to the invention, which is used in development of components and a system;

FIG. 3A, FIG. 3B, and FIG. 3C are diagrams each of which schematically shows a process in which the components and system are developed while models are transmitted between a system manufacturer and two component manufacturers;

FIG. 4A, FIG. 4B, and FIG. 4C are diagrams each of which schematically shows a process in which the components and system are developed while the models are transmitted between the system manufacturer and the two component manufacturers;

FIG. 5 is a diagram showing an example of a method of comparing concealed component models included in the system model and component models stored in repositories;

FIG. 6 is a flowchart of a model transmission method used to transmit the models between the system manufacturer and the component manufacturers when model-based vehicle development is performed;

FIG. 7A, FIG. 7B, and FIG. 7C are diagrams each of which schematically shows a process in which the components and system are developed while the models are transmitted between the system manufacturer and the two component manufacturers, FIG. 7A, FIG. 7B, and FIG. 7C being similar to FIG. 3A, FIG. 3B, and FIG. 3C, respectively; and

FIG. 8A, FIG. 8B, and FIG. 8C are diagrams each of which schematically shows a process in which the components and system are developed while the models are transmitted between the system manufacturer and the two component manufacturers, FIG. 8A, FIG. 8B, and FIG. 8C being similar to FIG. 4A, FIG. 4B, and FIG. 4C, respectively.

### DETAILED DESCRIPTION OF EMBODIMENTS

In the following description and the accompanying drawings, the present invention will be described in more detail with reference to example embodiments.

Hereinafter, a model transmission apparatus and a model transmission method according to the invention will be described in detail with reference to the drawings. The model transmission apparatus and the model transmission method according to the invention are used in model-based product development. Hereinafter, an example, in which the model transmission apparatus and the model transmission method are used in model-based vehicle development, will be described.

First, the model-based vehicle development will be briefly described. In conventional vehicle development, components of a vehicle and systems including the components are actually manufactured. Then, tests are actually conducted on the manufactured components and systems to evaluate the performance of the components and systems. Based on the results of the performance evaluation, improvements are made to the components and systems. This process is repeatedly performed. However, if the vehicle is developed using this method, it is necessary to manufacture a plurality of units of one component, which are different from each other in the design, and a plurality of units of one system, which are different from each other in the design. This increases the cost related to the development. Also, each time modifications are made to the design of the components and systems, the components and systems need to be manufactured and the tests need to be conducted on the components and systems. Thus, a long time is required for the development of the vehicle.

Recently, the development of the components and systems of the vehicle has been performed using simulation models (hereinafter, simply referred to as “models”) based on laws of physics. That is, the model-based vehicle development has been performed. In the model-based vehicle development, the components and systems of the vehicle are not actually manufactured, and models corresponding to the components and systems, that is, component models and system models are produced. The performance of the components and systems is evaluated using the produced component models and system models. Based on the results of the performance evaluation, improvements are made to the component models and the system models. This process is repeatedly performed. Then, the actual components and systems are manufactured in accordance with the component models and the system models that are finally completed.

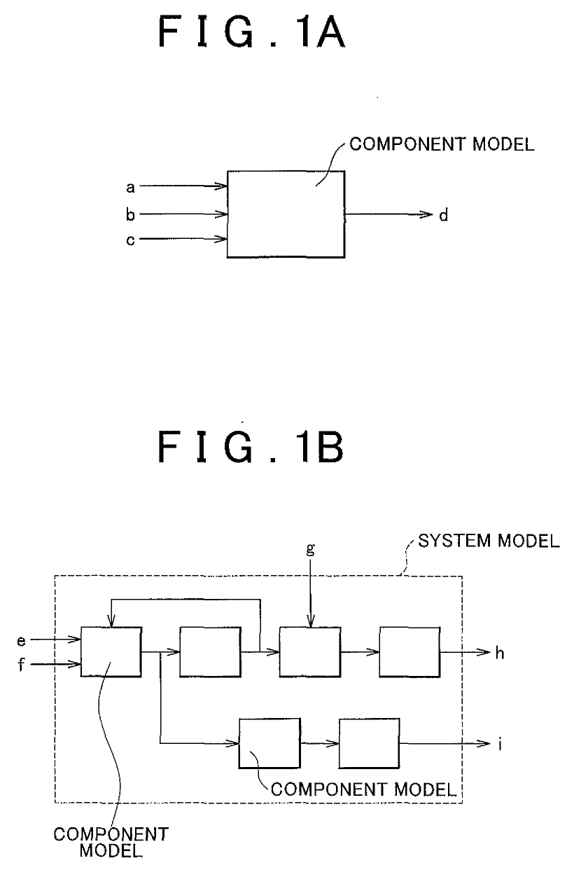

The component models and the system model will be briefly described with reference to FIGS. 1A and 1B. The term “the components of the vehicle” signifies components that constitute a vehicle or a system, and that can be modeled by simulation models. In the development of an intake system for an internal combustion engine, “the components of the vehicle” include, for example, an air cleaner, an intake pipe, a turbocharger, a throttle valve, a surge tank, an EGR valve, an intake manifold, and an intake valve. As shown in FIG. 1A, when values of predetermined parameters a, b, and c relating to a component are input to a component model corresponding to the component, the component model outputs a value of a predetermined parameter d that is influenced by the component. For example, when values of a throttle valve opening degree, an atmospheric pressure, and an atmospheric temperature are input, as input parameters, to a component model corresponding to the throttle valve, computations are performed using model equations set based the law of conservation of energy, the law of conservation of momentum, the law of conservation of mass, the equation of state, and the like. Then, the component model outputs, for example, a value of a flow rate of air passing through the throttle valve, as an output parameter.

The term “the system of the vehicle” signifies a system produced by combining a plurality of components that constitute the vehicle or the system. In the development of the intake system for the internal combustion engine, “the system of the vehicle” is the intake system that includes, for example, the air cleaner, the intake pipe, the turbocharger, the throttle valve, the surge tank, the EGR valve, the intake manifold, and the intake valve. As shown in FIG. 1B, when values of predetermined parameters e, f, and g relating to a system are input to a system model corresponding to the system, the system model outputs values of predetermined parameters h and i that are influenced by the system. For example, when values of the atmospheric pressure, the atmospheric temperature, the throttle valve opening degree, the EGR valve opening degree, and the engine speed are input, as input parameters, to the system model corresponding to the intake system, computations are performed using model equations relating to a plurality of the component models. Then, the system model outputs, for example, a value of an amount of air charged into a cylinder, as an output parameter

When the model-based vehicle development is performed in the above-described manner, the number of the components and systems of the vehicle that need to be actually manufactured is greatly reduced, and thus, the cost related to the development is reduced. Also, modifications are made to the design of the component models and system models only by changing the model equations or values used in the model equations. Accordingly, it is not necessary to manufacture the actual components and systems again when modifications are made to the design. This reduces the time required for the development.

A large number of components constitute the vehicle or the like. Therefore, all the components are not developed by one system manufacturer, and the components are usually developed by different manufacturers. In this case, in order to perform the model-based vehicle development, each component manufacturer, which independently develops the component, needs to produce the component model corresponding to the component, and needs to supply the component model to the system manufacturer. The system manufacturer produces the system model by combining the component models supplied by the component manufacturers, and evaluates the performance of the system using the system model. Particularly, because the produced system model is supplied to each component manufacturer, each component manufacturer can evaluate the entire system while making modifications to the component model corresponding to the component independently developed by the component manufacturer. Therefore, each component manufacturer can improve the component model so that the component model becomes the most appropriate model for the entire system. Thus, based on the specifications of the improved component model, each component manufacturer can manufacture the component designed most appropriately for the entire system.

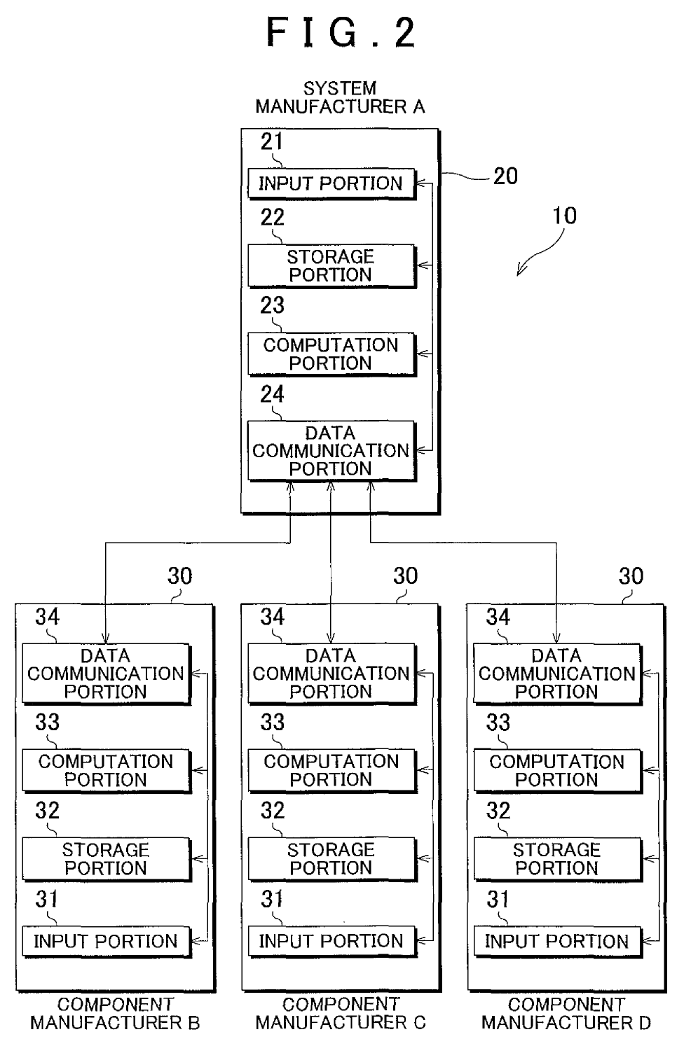

The model transmission apparatus or the model transmission method according to the invention is used to transmit the model between the system manufacturer and the component manufacturers when the model-based vehicle development is performed. FIG. 2 schematically shows a configuration of the model transmission apparatus according to the invention, which is used in the development of the components and the system.

As shown in FIG. 2, the model transmission apparatus 10 includes a computer 20 (may be referred to as “second computer 20”) for a system manufacturer A; and computers 30 (may be referred to as “first computers 30”) for a plurality of component manufacturers B, C, and D (three component manufacturers in an example shown in FIG. 2). In the embodiment, the system manufacturer A develops the entire system of the vehicle (i.e., the system manufacturer serves as OEM (Original Equipment Manufacturer), and the component manufacturers B, C, and D develop the components necessary for the system (i.e., the component manufacturers B, C, and D serve as suppliers).

Each of the computers 30 for the component manufacturers is connected to the computer 20 for the system manufacturer in an interactive communication environment. That is, in the embodiment, the computer 20 for the system manufacturer is connected to all the computers 30 for the component manufacturers. The computers 30 for the component manufacturers are not connected to each other.

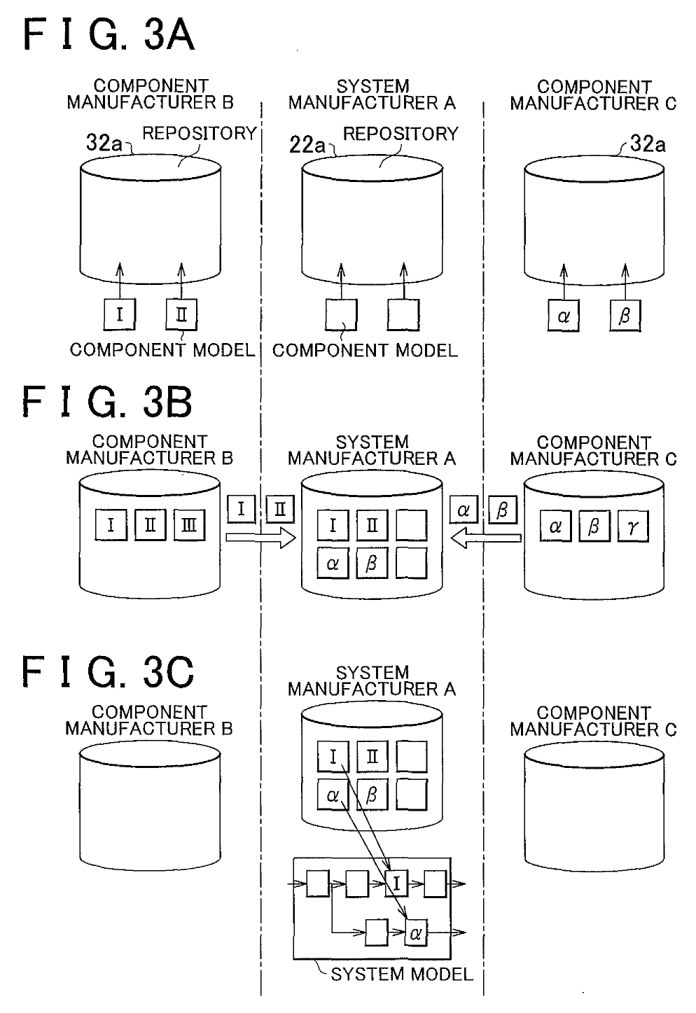

The computer 20 includes an input portion (may be referred to as “input device”) 21 through which a user inputs the system model and the like to the computer 20; a storage portion (may be referred to as “storage device”) 22 that includes a repository 22a (refer to FIG. 3) for the component models; a computation portion (may be referred to as “computation device”) 23 that performs a computation, for example, to produce the system model using the component models; and a data communication portion (may be referred to as “data communication device”) 24 that transmits/receives data to/from the computers 30. Each of the computers 30 includes an input portion (may be referred to as “input device”) 31 through which a user inputs the component model and the like to the computer 30; a storage portion (may be referred to as “storage device”) 32 that includes a repository 32a (refer to FIG. 3) for the component models; a computation portion (may be referred to as “computation device”) 33; and a data communication portion (may be referred to as “data communication device”) 34 that transmits/receives data to/from the computer 20.

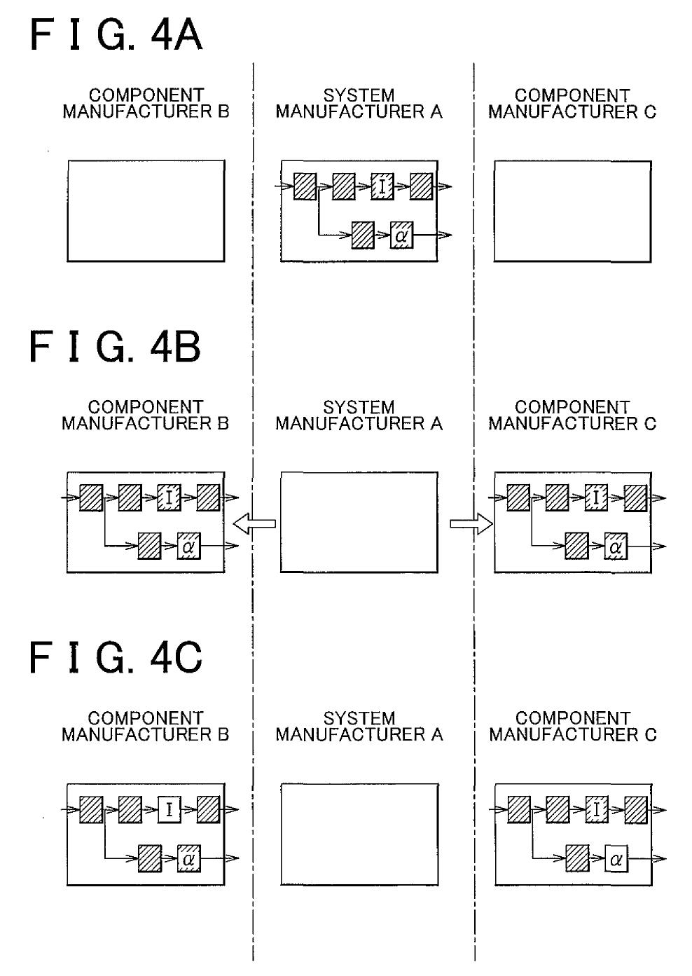

Next, the development of the components and the system using the model transmission apparatus with the above-described configuration will be described with reference to FIGS. 3A to 3C and FIGS. 4A to 4C. Each of FIGS. 3A to 3C and FIGS. 4A to 4C schematically shows a process in which the components and the system are developed while the models are transmitted between the system manufacturer A and the component manufacturers B and C.

As shown in FIG. 3A, the system manufacturer A possesses the repository 22a for the component models, in the storage portion 22 of the computer 20. Each of the component manufacturers B and C possesses the repository 32a for the component models, in the storage portion 32 of the computer 30. Each of the component manufacturers B and C is developing components to be provided in a new system. Thus, each of the component manufacturers B and C produces the component models by modeling the components, and stores the produced component models in the repository 32a of the computer 30 for the component manufacturer through the input portion 31 of the computer 30. In an example shown in FIGS. 3A to 3C, the component manufacturer B stores the component models I and II in the repository 32a, and the component manufacturer C stores the component models α and β in the repository 32a.

The system manufacturer A may independently develop components other than the components ordered by the system manufacturer A from the component manufacturers. In this case, the system manufacturer A produces the component models by modeling the components, and stores the produced component models in the repository 22a of the computer 20 for the system manufacturer through the input portion 21 of the computer 20.

Then, as shown in FIG. 3B, the component models I and II and the component models α and β stored in the repositories 32a of the component manufacturers are transmitted to the computer 20 for the system manufacturer via the data communication portions 34 of the computers 30 for the component manufacturers and the data communication portion 24 of the computer 20 for the system manufacturer. Thus, the component models I and II and the component models α and β are stored in the repository 22a of the computer 20. The component models may be automatically transmitted from the component manufacturers B and C to the system manufacturer A when the component models are stored in the repositories 32a of the computers 30 for the component manufacturers. Alternatively, among the component models stored in the repositories 32a of the computers 30 for the component manufacturers, only the component models designated by the user may be transmitted from the component manufacturers B and C to the system manufacturer A.

Because the component models produced by the component manufacturers B and C are stored in the repositories 22a of the computer 20 for the system manufacturer, all the component models necessary for producing the system model are stored in the repository 22a.

Then, as shown in FIG. 3C, the system model is produced by combining some of the component models stored in the repository 22a of the computer 20 for the system manufacturer (i.e., the component models produced by the system manufacturer A, and the component models I and II and the component models α and β produced by the component manufacturers B and C). The computation portion 23 of the computer 20 produces the system model by automatically combining the component models designated by the user, among the component models stored in the repository 22a of the computer 20 for the system manufacturer. More specifically, the component models stored in the repository 22a are indicated on a display screen (not shown) of the computer 20, which is visible to the user. Then, the user selects the component models to be combined, among the component models indicated on the display screen. The computation portion 23 of the computer 20 produces the system model by combining the selected component models.

Alternatively, the user may produce the system model by combining the component models stored in the repository 22a of the computer 20 for the system manufacturer. In this case, the user inputs the produced system model to the computer 20 through the input portion 21 of the computer 20.

Then, as shown in FIG. 4A, the computation portion 23 of the computer 20 for the system manufacturer conceals all the component models included in the system model (the hatched component models in FIG. 4 are the concealed component models). The phrase “the computation portion 23 conceals the component models” signifies that the computation portion 23 prevents analysis of the contents of the component models (i.e., the model equations and values used in the model equations) and the structure and specifications of the components corresponding to the component models, which can be estimated based on the model equations and the like. For example, the component models are converted to executable files, or programs of the component models are converted to machine language. With regard to concealment of the models, the entire system model is not concealed, and each of the component models is concealed.

Then, as shown in FIG. 4B, the produced system model is transmitted to the computers 30 for the component manufacturers B and C via the data communication portion 24 of the computer 20 for the system manufacturer and the data communication portions 34 of the computers 30 for the component manufacturers B and C. At this time, all the component models constituting the system model are concealed. Therefore, in this situation, the component manufacturers B and C cannot analyze any of the component models constituting the system model.

Then, the computation portion 33 of the computer 30 for each component manufacturer determines whether at least one of the concealed component models included in the system model transmitted to the computer 30 for the component manufacturer matches at least one corresponding component model stored in the repository 32a of the computer 30 for the component manufacturer. When the computation portion 33 determines that at least one concealed component model included in the system model matches at least one corresponding component model stored in the repository 32a, the computation portion 33 automatically replaces the at least one concealed component model included in the system model, with the at least one corresponding component model stored in the repository 32a (i.e., the at least one component model that is not concealed).

In the embodiment, the computation portion 33 of the computer 30 for each component manufacturer compares the concealed component models included in the system model with the component models stored in the repository 32a. When at least one concealed component model included in the system model matches at least one corresponding component model stored in the repository 32a, the at least one concealed component model included in the system model is automatically replaced with the at least one corresponding component model stored in the repository 32a.

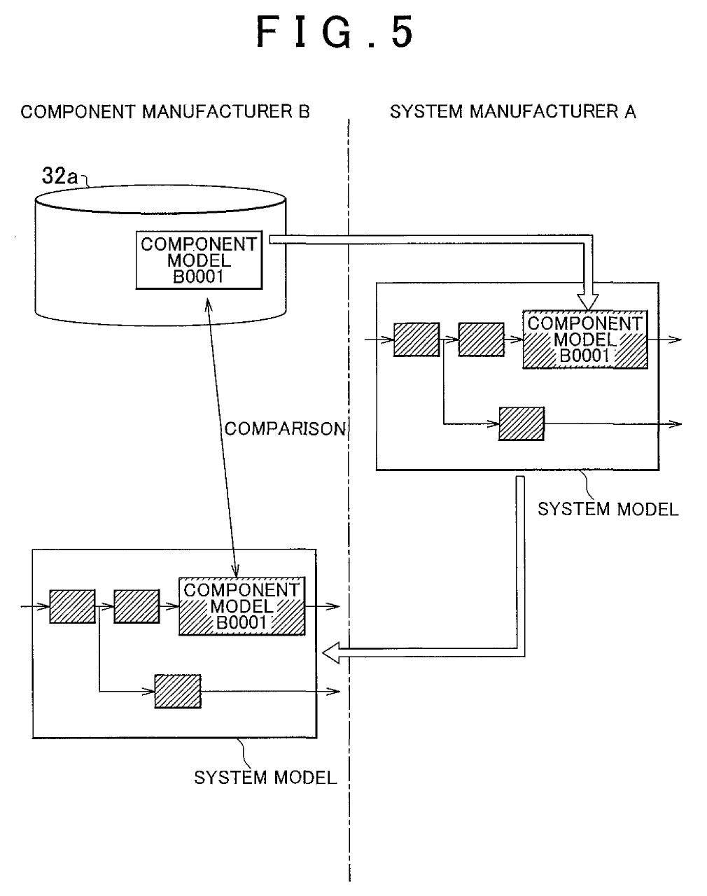

As a method of comparing the concealed component models included in the system model with the component models stored in the repository 32a, various methods may be employed. For example, a comparison method as shown in FIG. 5 may be employed.

In the method shown in FIG. 5, when each of the component manufacturers B and C inputs the produced component models into the computer 30 for the component manufacturer, a unique model number is associated with each component so that the same model number is not associated with two or more component models (it is to be noted that only the component manufacturer B is shown in FIG. 5). Then, when each of the component models included in the system model is concealed in the computer 20 for the system manufacturer or the like afterward, the model numbers remain associated with the component models, and the model numbers are not concealed. Then, the computation portion 33 of the computer 30 for each of the component manufacturers B and C compares the model numbers of the concealed component models included in the system model transmitted to the computer 30, with the model numbers of the component models stored in the repository 32a of the component manufacturer. When at least one model number of at least one component model included in the system model matches at least one model number of at least one component model in the repository 32a, the computation portion 33 replaces the at least one component model included in the system model, with the at least one component model in the repository 32a.

By performing the process shown in FIGS. 3A to 3C and FIGS. 4A to 4C, the system model is supplied to the component manufacturers B and C. Particularly, although the component models included in the supplied system model are basically concealed, the concealed component models developed by the component manufacturer B are replaced with the corresponding component models in the repository 32a of the component manufacturer B, and the concealed component models developed by the component manufacturer C are replaced with the corresponding component models in the repository 32a of the component manufacturer C. Therefore, the component manufacturers B and C can improve their component models included in the system model. Thus, when the component manufacturers B and C make improvements to their component models, the component manufacturers B and C can evaluate the influence of the improvements on the system model. That is, the component manufacturers B and C can make improvements to their component models taking into account the influence of the improvements on the entire system. Then, the users of the component manufacturers B and C input again the component models thus improved, to the repositories 32a of the computers 30 for the component manufacturers.

Then, in the above-described model transmission apparatus, the above-described operation is repeatedly performed. Thus, the component models are improved to optimize the performance of the entire system. Then, the actual components are manufactured in accordance with the improved component models. Because the configurations and design of the manufactured components and system have been made most appropriate using the models, it is not necessary to repeatedly conduct tests on the manufactured components and system, and to repeatedly make modifications to the design of the manufactured components and system. Thus, the cost of manufacturing the components or system for testing is maintained at a low level. Also, because it is not necessary to manufacture the actual components or system during the design and development phase, the design time can be reduced.

Next, the advantageous effects of the above-described model transmission apparatus will be described. In general, it is possible to learn the specifications, structure, and the like of the component by analyzing the component model corresponding to the component. Therefore, when the component manufacturer produces the component model, the component manufacturer is likely to refuse to supply the component model to other companies, if the other companies can learn the content of the component model. Particularly, the component manufacturer is most likely to refuse to supply the component model to other component manufacturers, if the other component manufacturers can learn the content of the component model. Accordingly, the component manufacturer does not want the system manufacturer to supply the system model including the component model developed by the component manufacturer, to the other component manufacturers.

However, in the above-described model transmission apparatus, the system model, in which the component models are basically concealed, is supplied to the component manufacturers. Therefore, it is possible to supply the system model to the component manufacturers without revealing the content of the component model of each component manufacturer to the other component manufacturers.

If the system model, in which all the component models are concealed, is supplied to the component manufacturers, the component manufacturers, which receive the system model, cannot improve their component models in the system model. In this case, each time improvements are made to the component models, the component manufacturers need to supply the component models to the system manufacturer, and the system manufacturer needs to produce the system model including the improved component models, to evaluate the influence of the improvements on the system model.

In contrast, in the above-described model transmission apparatus, although the component models included in the system model supplied to each component manufacturer are basically concealed, at least one concealed component model supplied by a component manufacturer is replaced with at least one corresponding component model in the repository 32a of the component manufacturer. Therefore, the above-described operation does not need to be performed. This reduces the number of man hours required to improve the component models and the system model.

Further, when the system manufacturer conceals the component models included in the system model, the system manufacturer may conceal the component models except the component models produced by the component manufacturer to which the system model is supplied, and may supply the system model thus produced to each component manufacturer. However, if the system model is supplied in this manner, it is difficult to control the concealment of the component models, because the component models to be concealed vary depending on the component manufacturer to which the system model is supplied. Particularly, when a plurality of component manufacturers relate to the system model, it is significantly difficult to control the concealment of the component models.

However, in the above-described model transmission apparatus, the system manufacturer transmits the system model in which all the component models are concealed, to each component manufacturer. Thus, it is not necessary to control the concealment of the component models.

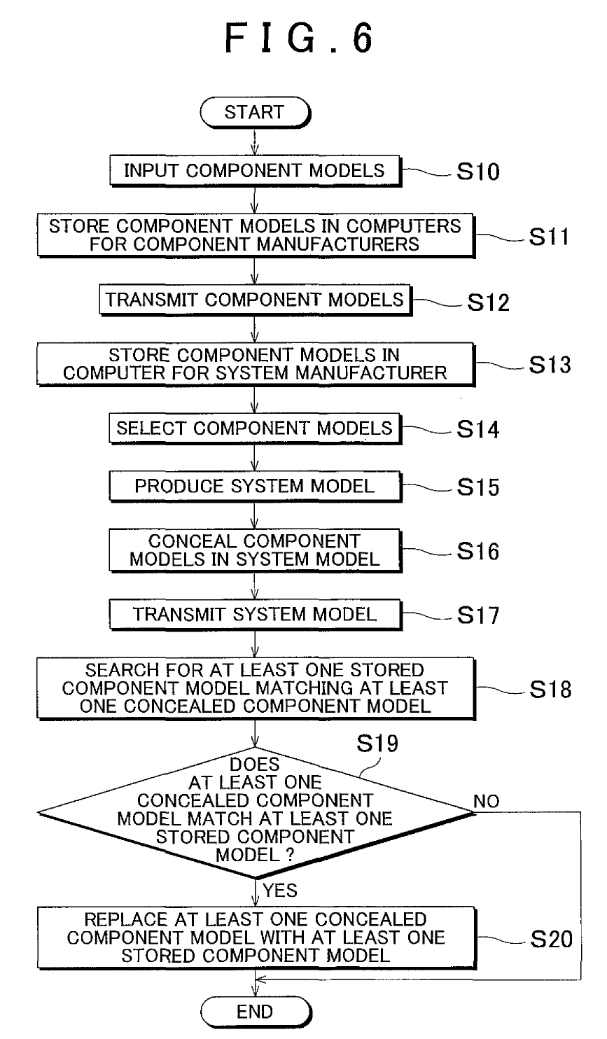

FIG. 6 is a flowchart of a model transmission method used to transmit the models between the system manufacturer and the component manufacturers when the model-based vehicle development is performed. First in step S10, the users of the component manufacturers input the component models to the computers 30 for the component manufacturers through the input portions 31. When the component models are input to the computers 30, the model numbers associated with the component models are input to the computers 30 at the same time.

Then, in step S11, the component models input through the input portions 31 are stored in the repositories 32a in the storage portions 32 of the computers 30 for the component manufacturers. Because all the component models input through the input portions 31 are stored in the repositories 32a, a plurality of component models are stored in each of the repositories 32a.

In step S12, the component models stored in the repositories 32a of the computers 30 for the component manufacturers are transmitted to the repository 22a in the storage portion 20 of the computer 20 for the system manufacturer via the data communication portions 34 of the computers 30 for the component manufacturers and the data communication portion 24 of the computer 20 for the system manufacturer. Then, in step S13, the transmitted component models are automatically stored in the repository 22a of the computer 20 for the system manufacturer. Because a plurality of component models are transmitted from a plurality of component manufacturers into the repository 22a of the computer 20, a plurality of component models are stored in the repository 22a.

Then, in step S14, the user selects several component models from among the plurality of component models stored in the repository 22a of the computer 20 for the system manufacturer. The user selects the component models through the input portion 21 of the computer 20 for the system manufacturer.

In step S15, the computation portion 23 of the computer 20 produces the system model by combining the several component models selected in step S14. Then, in step S16, the computation portion 23 conceals all the component models include in the system model produced in step S15.

Then, in step S17, the system model is transmitted from the computer 20 for the system manufacturer to the computers 30 for the component manufacturers via the data communication portions 24 and 34. Then, in step S18, in the repository 32a of the computer 30 for each component manufacturer, at least one corresponding component model that matches at least one concealed component model included in the system model transmitted to the computer 30 is searched for. In step S19, the computation portion 33 of the computer 30 for each component manufacturer determines whether at least one concealed component model included in the system model matches at least one corresponding component model in the repository 32a. When the computation portion 33 determines that at least one concealed component model included in the system model matches at least one corresponding component model in the repository 32a, the routine proceeds to step S20. In step S20, the at least one concealed component model included in the system model is replaced with the at least one corresponding component model stored in the repository 32a.

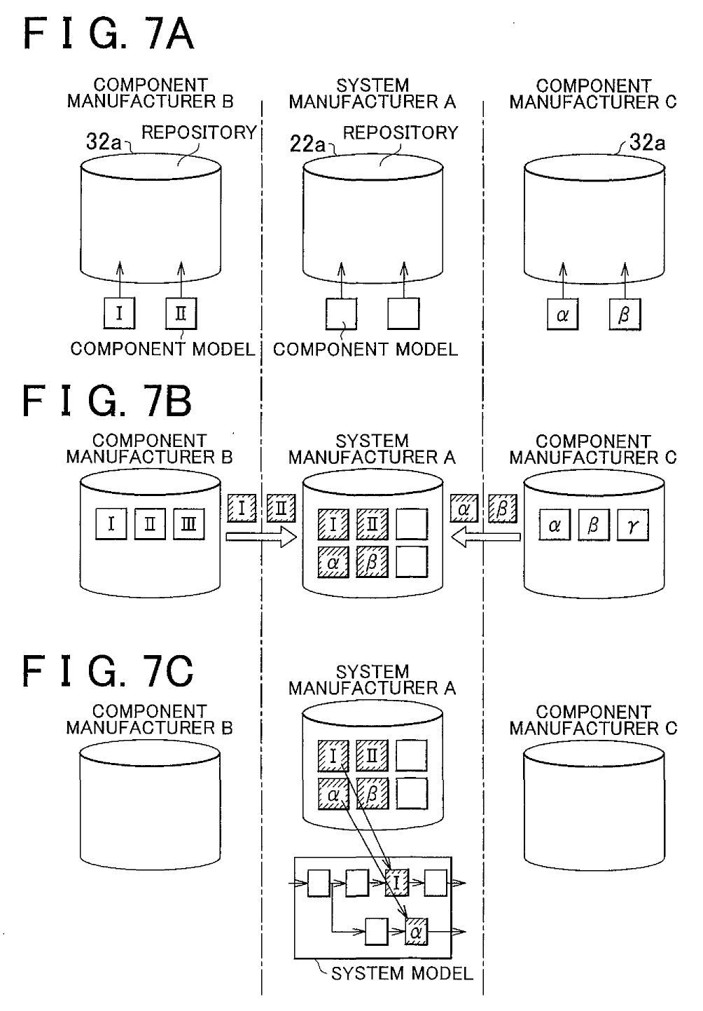

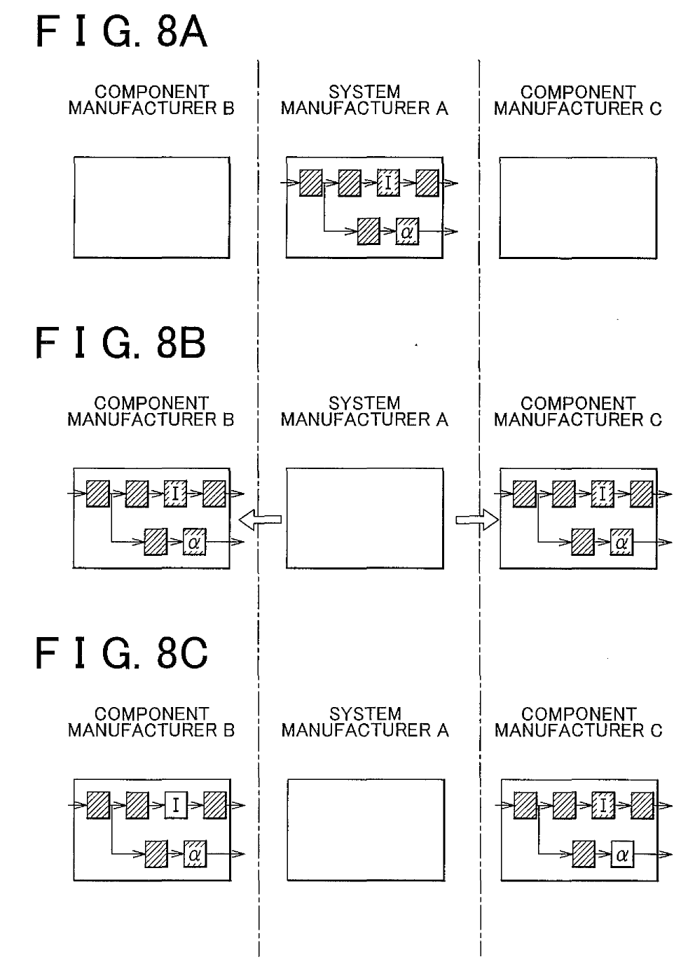

In the above-described embodiment, the component models included in the system model are concealed after the system model is produced in the computer 20 for the system manufacturer. However, the timing at which the component models are concealed is not limited to this timing. For example, as shown in FIG. 7 and FIG. 8, the component models may be concealed during after the component models are stored in the repositories 32a of the component manufacturers B and C, until the component models are transmitted to the repository 22a of the system manufacturer A.

Thus, the system manufacturer A receives the concealed component models. Therefore, the contents of the component models developed by the component manufacturers B and C are not revealed to the system manufacturer A. Also, the concealed component models are stored in the repositories 32a of the computers 30 for the component manufacturers. Therefore, when the component models included in the system model are compared with the component models stored in the repository 32a of each component manufacturer, it can be determined whether at least one component model included in the system model matches at least one corresponding component model in the repository 32a, by determining whether the code (machine language) of at least one component model included in the system model matches the code (machine language) of at least one component model in the repository 32a.

The example, in which the model transmission apparatus is used in the development of the vehicle, has been described. However, the model transmission apparatus need not necessarily be used in the vehicle development. The model transmission apparatus may be used in any product development, as long as the model transmission apparatus is used in the development of a system constituted by a plurality of components.

While the invention has been described with reference to example embodiments thereof it is to be understood that the invention is not limited to the example embodiments or constructions. To the contrary, the invention is intended to cover various modifications and equivalent arrangements. In addition, while the various elements of the example embodiments are shown in various combinations and configurations, which are exemplary, other combinations and configurations, including more, less or only a single element, are also within the spirit and scope of the invention.

What is claimed is:

1. A model transmission apparatus used when producing or improving a system model that is used to perform simulation analysis of a system constituted by a plurality of components, and that is produced by combining component models corresponding to the components, comprising:
a plurality of first computers used by respective component model suppliers; and
a second computer used by a system model producer,
wherein:
each of the first computers includes a first input device through which a user inputs, to the first computer, at least one component model produced by the user, a first storage device that stores the at least one component model that is input, and a first transmission device that transmits the at least one component model that is input, to the second computer;
the second computer includes a second storage device that stores the at least one component model transmitted by the first transmission device of each of the first computers, and a second transmission device that transmits, to each of the first computers, the system model produced by combining at least two component models among the component models stored in the second storage device of the second computer;
when the system model is transmitted by the second transmission device, the component models included in the system model are concealed; and
when at least one of the concealed component models included in the system model transmitted by the second transmission device matches at least one corresponding component model stored in the first storage device of at least one of the first computers, the at least one of the first computers automatically replaces the at least one of the concealed component models with the at least one corresponding unconcealed component model stored in the first storage device of the at least one of the first computers.

2. The model transmission apparatus according to claim 1, wherein the second computer produces the system model by combining the at least two component models designated by a user, among the component models stored in the second storage device of the second computer.

3. The model transmission apparatus according to claim 1, wherein the second computer further includes a second input device through which a user inputs, to the second computer, the system model produced by the user using the component models stored in the second storage device of the second computer.

4. The model transmission apparatus according to claim 1, wherein each of the first computers searches for the at least one corresponding component model that matches the at least one of the concealed component models included in the system model, in the first storage device of the first computer.

5. The model transmission apparatus according to claim 1, wherein each of the first computers conceals the at least one component model before the first transmission device transmits the at least one component model to the second computer.

6. The model transmission apparatus according to claim 1, wherein the second computer conceals all the component models included in the system model before the second transmission device transmits the system model to each of the first computers.

7. A model transmission method used when producing or improving a system model that is used to perform simulation analysis of a system constituted by a plurality of components, and that is produced by combining component models corresponding to the components, wherein the models are transmitted between a plurality of first computers used by respective component model suppliers, and a second computer used by a system model producer, comprising:
inputting at least one component model produced by a user to a first storage device of each of the first computers;
transmitting the at least one component model input to the first storage device, from each of the first computers to the second computer;
storing the at least one component model transmitted from each of the first computers to the second computer, in a second storage device of the second computer; and
transmitting the system model produced by combining at least two component models among the component models stored in the second storage device of the second computer, from the second computer to each of the first computers,
wherein:
when the system model is transmitted from the second computer to each of the first computers, the component models included in the system model are concealed; and
when at least one of the concealed component models included in the system model transmitted to each of the first computers matches at least one corresponding component model stored in the first storage device of at least one of the first computers, the at least one of the concealed component models is automatically replaced with the at least one corresponding unconcealed component model stored in the first storage device of the at least one of the first computers.

8. The model transmission method according to claim 7, further comprising:
producing the system model by combining at least two component models designated by a user, among the component models stored in the second storage device of the second computer.

9. The model transmission method according to claim 7, further comprising
inputting, to the second storage device of the second computer, the system model produced by a user, using the component models stored in the second storage device of the second computer.

10. The model transmission method according to claim 7, further comprising
searching for the at least one corresponding component model that matches the at least one of the concealed component models included in the system model, in the first storage device of each of the first computers.

11. The model transmission method according to claim 7, further comprising
concealing the at least one component model before the at least one component model is transmitted from each of the first computers to the second computer.

12. The model transmission method according to claim 7, further comprising
concealing all the component models included in the system model, before the system model is transmitted from the second computer to each of the first computers.
